(19) United States
(12) Patent Application Publication
(10) Pub. No.: US 2008/0030135 A1
(43) Pub. Date: Feb. 7, 2008

(54) PLASMA DISPLAY PANEL

(76) Inventors: Jong Woon BAE, Gumi-si (KR); Gyung Rae KIM, Dalseo-gu (KR); Seong Hwan RYU, Guri-si (KR); Ki Rack PARK, Chilgok-gun (KR)

Correspondence Address: KED & ASSOCIATES, LLP, P.O. Box 221200, Chantilly, VA, 20153-1200, US

(21) Appl. No.: 11/835,021

(22) Filed: Aug. 7, 2007

(30) Foreign Application Priority Data
Aug. 7, 2006 (KR) 10-2006-0074443

(51) Int. Cl. H01J 17/49

(52) U.S. Cl. 313/582

(57) ABSTRACT

A plasma display panel is disclosed. The plasma display panel includes a front substrate, a rear substrate, and a barrier rib which is positioned between the front substrate and the rear substrate and partitions a discharge cell. The discharge cell is filled with a discharge gas including 10 to 30 wt % of xenon (Xe) based on total weight of the discharge gas. The barrier rib comprises a first barrier rib and a second barrier rib intersecting each other. A height of the first barrier rib is substantially the same as a height of the second barrier rib. An exhaust unit is omitted from the front substrate and the rear substrate.

This application claims the benefit of Korean Patent Application No. 10-2006-0074443 filed on Aug. 7, 2006, which is hereby incorporated by reference.

### BACKGROUND OF THE DISCLOSURE

1. Field of the Disclosure

This document relates to a plasma display panel.

2. Description of the Related Art

A plasma display panel includes a phosphor layer inside discharge cells partitioned by barrier ribs and a plurality of electrodes.

A driving signal is supplied to the discharge cells through the electrodes, thereby generating a discharge inside the discharge cells.

When the driving signal generates the discharge inside the discharge cells, a discharge gas filled in the discharge cells generates vacuum ultraviolet rays, which thereby cause phosphors formed inside the discharge cells to emit light, thus displaying an image on the screen of the plasma display panel.

### SUMMARY OF THE DISCLOSURE

In one aspect, a plasma display panel comprises a front substrate on which a first electrode and a second electrode are positioned in parallel, a rear substrate, opposite to the front substrate, on which a third electrode is positioned to intersect the first electrode and the second electrode, and a barrier rib which is positioned between the front substrate and the rear substrate and partitions a discharge cell, wherein the discharge cell is filled with a discharge gas including 10 to 30 wt % of xenon (Xe) based on total weight of the discharge gas, the barrier rib comprises a first barrier rib and a second barrier rib intersecting each other, a height of the first barrier rib is substantially the same as a height of the second barrier rib, and an exhaust unit is omitted from the front substrate and the rear substrate.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIGS. 1 to 4 illustrate a structure of a plasma display panel according to an exemplary embodiment;

FIG. 5 illustrates a process for fabricating a plasma display panel according to an exemplary embodiment not including an exhaust unit;

FIG. 6 is a graph showing a relationship between xenon (Xe) content and a luminance depending on whether or not there is an exhaust unit;

FIG. 7 is a graph showing a relationship between Xe content and a discharge voltage depending on whether or not there is an exhaust unit;

FIG. 8 illustrates a reason why a first electrode and a second electrode have a single-layered structure in a plasma display panel not including an exhaust tip;

FIG. 9 illustrates a structure of a plasma display panel in which a black layer is added between first and second electrodes and a front substrate;

FIG. 10 illustrates a first exemplary embodiment associated with a first electrode and a second electrode in a plasma display panel according to an exemplary embodiment;

FIGS. 11 to 13 illustrate a second exemplary embodiment associated with a first electrode and a second electrode in a plasma display panel according to an exemplary embodiment;

FIG. 14 illustrates a third exemplary embodiment associated with a first electrode and a second electrode in a plasma display panel according to an exemplary embodiment;

FIG. 15 illustrates a fourth exemplary embodiment associated with a first electrode and a second electrode in a plasma display panel according to an exemplary embodiment;

FIG. 16 illustrates a fifth exemplary embodiment associated with a first electrode and a second electrode in a plasma display panel according to an exemplary embodiment;

FIG. 17 illustrates a sixth exemplary embodiment associated with a first electrode and a second electrode in a plasma display panel according to an exemplary embodiment;

FIGS. 18 and 19 illustrate a seventh exemplary embodiment associated with a first electrode and a second electrode in a plasma display panel according to an exemplary embodiment;

FIG. 20 illustrates an eighth exemplary embodiment associated with a first electrode and a second electrode in a plasma display panel according to an exemplary embodiment;

FIG. 21 illustrates a ninth exemplary embodiment associated with a first electrode and a second electrode in a plasma display panel according to an exemplary embodiment;

FIG. 22 illustrates a tenth exemplary embodiment associated with a first electrode and a second electrode in a plasma display panel according to an exemplary embodiment;

FIGS. 23 and 24 illustrate an eleventh exemplary embodiment associated with a first electrode and a second electrode in a plasma display panel according to an exemplary embodiment;

FIG. 25 illustrates a frame for achieving a gray scale of an image displayed on a plasma display panel according to an exemplary embodiment;

FIG. 26 illustrates an operation of a plasma display panel according to an exemplary embodiment;

FIGS. 27 and 28 illustrate another form of a rising signal and a second falling signal; and

FIG. 29 illustrates another type of a sustain signal.

### DETAILED DESCRIPTION OF EMBODIMENTS

A plasma display panel comprises a front substrate on which a first electrode and a second electrode are positioned in parallel, a rear substrate, opposite to the front substrate, on which a third electrode is positioned to intersect the first electrode and the second electrode, and a barrier rib which is positioned between the front substrate and the rear substrate and partitions a discharge cell, wherein the discharge cell is filled with a discharge gas including 10 to 30 wt % of xenon (Xe) based on total weight of the discharge gas, the barrier rib comprises a first barrier rib and a second barrier rib intersecting each other, a height of the first barrier rib is substantially the same as a height of the second barrier rib, and an exhaust unit is omitted from the front substrate and the rear substrate.

A seal layer may be positioned between the front substrate and the rear substrate, and coalesce the front substrate and the rear substrate, and the seal layer may comprise a photo-crosslinked material.

The discharge gas may comprise 13 to 30 wt % of Xe based on total weight of the discharge gas.

At least one of the first electrode or the second electrode may comprise one layer.

The first electrode and the second electrode may be positioned symmetrically each other inside the discharge cell.

A black layer may be positioned on at least one of the first electrode or the second electrode.

At least one of the first electrode or the second electrode may comprise a line portion intersecting the third electrode and a projecting portion, which is positioned in parallel to the third electrode and projects from the line portion.

At least one of the first electrode or the second electrode may comprise a plurality of line portions and a connection portion connecting the plurality of the line portions.

At least one of the first electrode or the second electrode may comprise a plurality of the line portions and a plurality of connection portions connecting the plurality of the line portions, and the plurality of connection portions may be arranged in the form of a straight line.

The projecting portion comprises a first projecting portion and a second projecting portion, and the first projecting portion may project in a first direction and the second projecting portion may project in a second direction different from the first direction.

The projecting portion may have an end of a curved surface.

At least one of the first electrode or the second electrode may comprise a first line portion and a second line portion, and a width of the first line portion close to a center of a discharge cell may be less than a width of the second line portion close to a barrier rib.

At least one of the first electrode or the second electrode may comprise a first line portion and a second line portion, and a width of the first line portion close to a center of a discharge cell may be larger than a width of the second line portion close to a barrier rib.

At least one of the first electrode or the second electrode may comprise a first line portion and a second line portion, and a length of the first line portion close to a center of a discharge cell may be less than a length of the second line portion close to a barrier rib.

The connection portion may project at a given angle to the line portion.

At least one of the first electrode or the second electrode may comprise a plurality of projecting portions, and a thickness of a portion of the projecting portion may be greater than a thickness of the rest portion of the projecting portion, and wherein the portion of the projecting portion may be positioned between the plurality of projecting portions.

One layer may be a bus electrode.

The exhaust unit may comprise an exhaust hole.

The discharge cell may comprise a first discharge cell and a second discharge cell, a first phosphor may be positioned inside the first discharge cell, and a second phosphor may be positioned inside the second discharge cell, and a thickness of the first phosphor may be different from a thickness of the second phosphor.

Embodiments will be described in a more detailed manner with reference to the attached drawings.

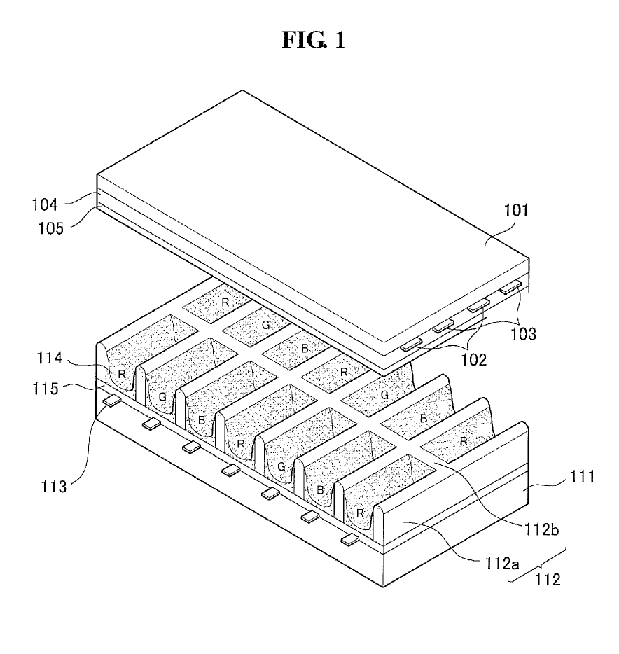

FIGS. 1 to 4 illustrate a structure of a plasma display panel according to an exemplary embodiment.

As illustrated in FIG. 1, the plasma display panel according to an exemplary embodiment includes a front substrate 101 and a rear substrate 111 which coalesce each other. A first electrode 102 and a second electrode 103 are positioned on the front substrate 101 in parallel to each other. A third electrode 113 is positioned on the rear substrate 111 to intersect the first electrode 102 and the second electrode 103.

The first electrode 102 and the second electrode 103 may include a single layer. For instance, the first electrode 102 and the second electrode 103 may be a non-transparent electrode (i.e., an ITO (indium-tin-oxide)-less electrode).

A color of at least one of the first electrode 102 or the second electrode 103 may be darker than a color of an upper dielectric layer 104, which will be described later.

There is no exhaust unit on the rear substrate 111. There may be no exhaust unit on both the front substrate 101 and the rear substrate 111. The exhaust unit may be at least one of an exhaust hole, an exhaust tip, or an exhaust pipe.

The exhaust unit will be described in detail later with reference to FIG. 5.

Driving voltages are supplied to the first electrode 102 and the second electrode 103 to generate a discharge inside discharge cells and maintain a state of the discharge.

The upper dielectric layer 104 for covering the first electrode 102 and the second electrode 103 is formed on the front substrate 101 on which the first electrode 102 and the second electrode 103 are positioned.

The upper dielectric layer 104 limits discharge currents of the first electrode 102 and the second electrode 103, and provides electrical insulation between the first electrode 102 and the second electrode 103.

A protective layer 105 is positioned on an upper surface of the upper dielectric layer 104 to facilitate discharge conditions. The protective layer 105 may be formed by deposing a material such as magnesium oxide (MgO) on the upper dielectric layer 104.

A lower dielectric layer 115 for covering the third electrode 113 is formed on the rear substrate 111 on which the third electrode 113 is positioned. The lower dielectric layer 115 provides electrical insulation between the third electrodes 113.

Barrier ribs 112 of a stripe type, a well type, a delta type, a honeycomb type, and the like, are positioned on the lower dielectric layer 115 to partition discharge cells. Red (R), green (G) or blue (B) discharge cells are formed between the front substrate 101 and the rear substrate 111.

In addition to the red (R), green (G), and blue (B) discharge cells, a white (W) or yellow (Y) discharge cell may be further added.

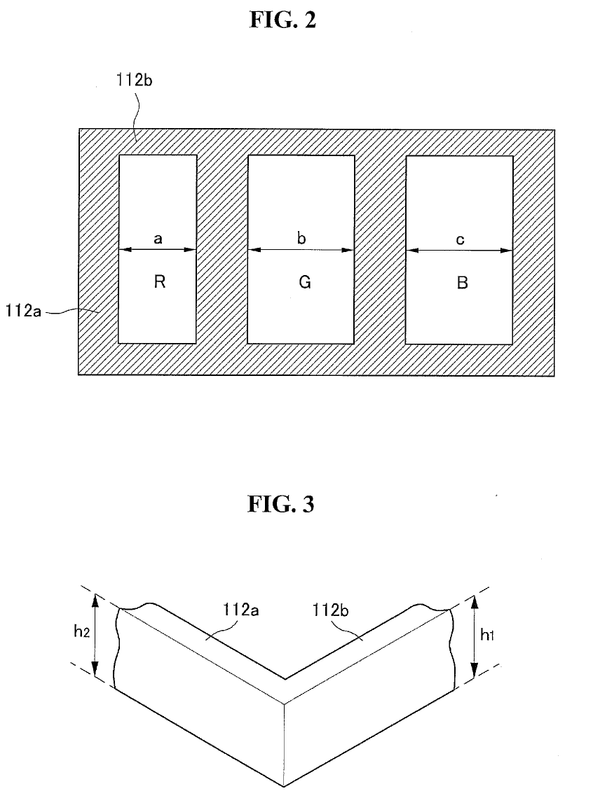

Pitches of the red (R), green (G), and blue (B) discharge cells may be substantially equal to one another. However, the pitches of the red (R), green (G), and blue (B) discharge cells may be different from one another as illustrated in FIG. 2 to control a white balance in the red (R), green (G), and blue (B) discharge cells.

The pitches of all of the red (R), green (G), and blue (B) discharge cells may be different from one another, or alternatively, the pitch of at least one of the red (R), green (G), and blue (B) discharge cells may be different from the pitches of the other discharge cells. For instance, as illustrated in FIG. 2, a pitch (a) of the red (R) discharge cell is the smallest, and pitches (b and c) of the green (G) and blue (B) discharge cells are larger than the pitch (a) of the red (R) discharge cell. The pitch (b) of the green (G) discharge cell may be substantially equal to or different from the pitch (c) of the blue (B) discharge cell.

The barrier rib 112, as illustrated in FIG. 1, includes a first barrier rib 112b and a second barrier rib 112a. As illustrated in FIG. 3, a height h1 of the first barrier rib 112b may be substantially equal to a height h2 of the second barrier rib 112a.

There is no exhaust channel or groove on the first and second barrier ribs 112b and 112a

While the red (R), green (G), and blue (B) discharge cells are arranged on the same line in an exemplary embodiment, it is possible to arrange the discharge cells in a different arrangement form. For instance, a delta type arrangement in which the red (R), green (G), and blue (B) discharge cells are arranged in a triangle shape may be applicable. Further, the discharge cells may have a variety of polygonal shapes such as pentagonal and hexagonal shapes as well as a rectangular shape.

Each of the discharge cells partitioned by the barrier ribs 112 is filled with a predetermined discharge gas. The discharge gas contains xenon (Xe) equal to or more than about 10% based on total weight of the discharge gas. The discharge gas will be described in detail later.

The phosphor layers 114 for emitting visible light for an image display during the occurrence of an address discharge are formed inside the discharge cells partitioned by the barrier ribs 112. For instance, red (R), green (G) and blue (B) phosphor layers may be formed inside the discharge cells. A white (W) phosphor layer and/or a yellow (Y) phosphor layer may be further formed in addition to the red (R), green (G) and blue (B) phosphor layers.

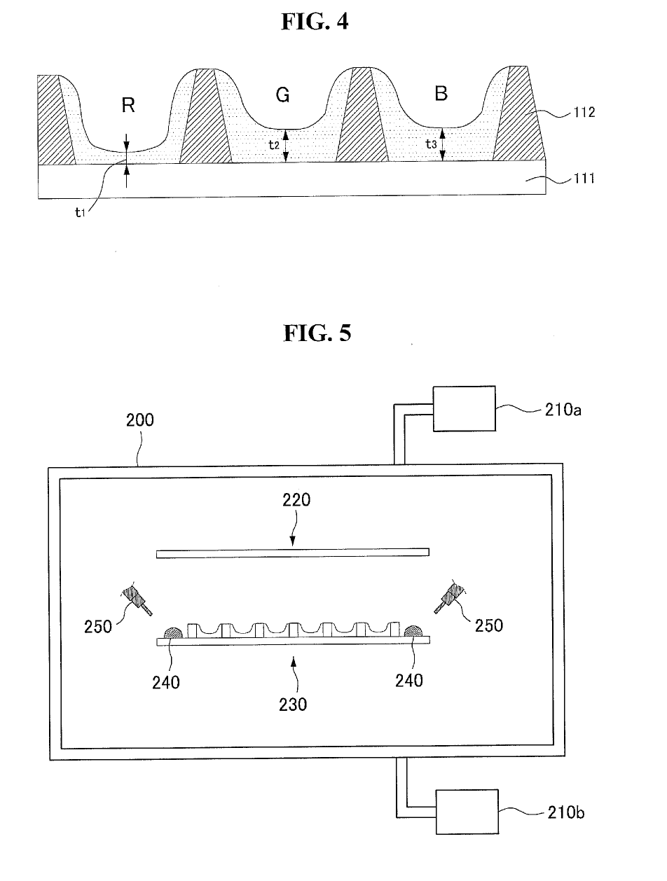

The thicknesses of the red (R), green (G) and blue (B) phosphor layers 114 may be substantially equal to or different from each other. For instance, as illustrated in FIG. 4, thicknesses t2 and t3 of the green (G) and blue (B) phosphor layers are larger than a thickness t1 of the red (R) phosphor layer. The thickness t2 of the green (G) phosphor layer may be substantially equal to or different from the thickness t3 of the blue (B) phosphor layer.

It should be noted that only one example of the plasma display panel according to an exemplary embodiment has been illustrated and described above, and the present embodiment is not limited to the plasma display panel with the above-described structure. For instance, while the above description illustrates a case where the upper dielectric layer 104 and the lower dielectric layer 115 each have a single-layered structure, at least one of the upper dielectric layer 104 and the lower dielectric layer 115 may have a multi-layered structure.

A black layer (not shown) capable of absorbing external light may be positioned on the barrier rib 112 to prevent the reflection of the external light caused by the barrier rib 112. Further, another black layer (not shown) may be positioned on the front substrate 101 corresponding to the barrier rib 112. The third electrode 113 formed on the rear substrate 111 may have a substantially constant width or thickness. The width or thickness of the third electrode 113 on the rear substrate 111 may be substantially constant. However, the width or thickness of the third electrode 113 inside the discharge cell may be different from the width or thickness of the third electrode 113 outside the discharge cell. For instance, the width or thickness of the third electrode 113 inside the discharge cell may be larger than the width or thickness of the third electrode 113 outside the discharge cell. Hence, the address discharge can easily occurs inside the discharge cells.

FIG. 5 illustrates a process for fabricating a plasma display panel according to an exemplary embodiment not including an exhaust unit.

Referring to FIG. 5, a reference numeral 200 indicates a chamber in which a front substrate 220 and a rear substrate 230 are positioned. A reference numeral 210a indicates an exhaust portion for exhausting a gas filled in the chamber 200 to the outside. A reference numeral 210b indicates a gas injection unit for injecting a discharge gas into the chamber 200. A reference numeral 250 indicates a firing unit for firing a seal layer 240.

First, the front substrate 220 and the rear substrate 230 going through predetermined fabrication processes are positioned inside the chamber 300. The seal layer 240 is positioned between the front substrate 220 and the rear substrate 230 to coalesce the front substrate 220 and the rear substrate 230.

The exhaust portion 210a exhausts a gas filled in the chamber 200. In other words, the exhaust portion 210a exhausts an impure gas inside the chamber 200 to the outside.

Next, a discharge gas is injected into the chamber 200 through the gas injection unit 210b. More specifically, the gas injection unit 210b injects a discharge gas such as Xe, neon (Ne), argon (Ar) into the chamber 200 so that a pressure of the chamber 200 ranges from about 4×10⁻² to 2 torr at a temperature of about 200 to 400° C.

The discharge gas includes 10 to 30 wt % of Xe based on total weight of the discharge gas.

The front substrate 220 and the rear substrate 230 coalesce using a predetermined coalescence device (not shown). The firing unit 250 applies heat or light to the seal layer 240 to harden the seal layer 240. As a result, the front substrate 220 and the rear substrate 230 coalesce sufficiently strongly.

The seal layer 240 may include a photo-crosslinked material. The firing unit 250 applies light to the seal layer 240 including a photo-crosslinked material when the front substrate 220 and the rear substrate 230 coalesce, thereby hardening and firing the seal layer 240. Thus, the above processes prevent an impure gas generated when the seal layer 240 is fired.

When the plasma display panel is formed through a coalescence process of the front substrate 220 and the rear substrate 230, the coalescence process and a process for injecting the discharge gas into the discharge cell can performed simultaneously. Therefore, the front substrate 220 and the rear substrate 230 do not need to have an exhaust unit (for instance, an exhaust hole). In other words, the exhaust hole may be omitted from the front substrate 220 and the rear substrate 230.

As above, since the exhaust hole is omitted, there may be no exhaust tip for connecting the gas injection unit injecting the discharge gas through an exhaust hole to the front and rear substrates 220 and 230.

In case that an exhaust process of an impure gas inside a plasma display panel and an injection process of a discharge gas are performed using an exhaust tip, the exhaust tip is positioned at a specific position of the plasma display panel. Further, since the exhaust process and the gas injection process are performed after a coalescence process, there is a great likelihood that the impure gas remains inside the plasma display panel (i.e., inside the discharge cells). Thus, because the impure gas interferes with a discharge of the plasma display panel including the exhaust tip, a firing voltage greatly increases, the discharge occurs unstably due to the deviation in the exhaust amount of the impure gas, and a driving efficiency is reduced.

On the other hand, as illustrated in FIG. 5, when the coalescence process and the gas injection process are performed simultaneously, the impure gas is removed completely and the discharge gas is injected sufficiently uniformly.

When there is no exhaust tip in the plasma display panel, as illustrated in FIG. 5, a stable discharge occurs at a low firing voltage level.

The plasma display panel including the exhaust tip is fabricated by sequentially performing a coalescence process, an attaching process of an exhaust tip, an exhaust process, a gas injection process, and the like. On the other hand, since the exhaust process and the gas injection process are simultaneously performed during the coalescence process in the plasma display panel not including an exhaust tip, the number of fabrication processes and fabrication time are reduced and the fabrication cost is reduced.

Because the discharge gas is uniformly distributed in the plasma display panel not including an exhaust tip, a groove, a depression or a channel for the smooth exhaust are not necessary. Accordingly, since a process for forming the groove, the depression or the channel on the barrier rib is omitted, the fabrication time and the fabrication cost are reduced. Further, because there are no groove, no depression and no channel on the barrier rib, the occurrence of cross-talk is prevented.

Since the plasma display panel according to an exemplary embodiment does not include the exhaust tip, the discharge gas can be uniformly distributed inside the plasma display panel and a firing voltage can be lowered. Therefore, a content of Xe in the discharge gas may increase.

Xe has a characteristic capable of increasing the generation of vacuum ultraviolet rays during the generation of a discharge. Therefore, when a content of Xe in the discharge gas increases, the quantity of light generated in the discharge cell increases and a luminance of an image increases. However, Xe increases the firing voltage.

For instance, when Xe content is equal to 2 wt % based on total weight of the discharge gas, a firing voltage is equal to 150V. In this case, it is assumed that the quantity of light generated by one driving signal is quantitatively equal to 100.

When Xe content is 10 wt % based on total weight of the discharge gas, a firing voltage is equal to 250V and the quantity of light generated by one driving signal is quantitatively equal to 150. In other words, as Xe content increases, the quantity of light increases and a luminance increases. However, the firing voltage greatly increases.

On the other hand, the discharge gas is uniformly injected into the plasma display panel not including the exhaust tip according to an exemplary embodiment and the firing voltage is relatively low. Therefore, although Xe content is set to be relatively large, an excessive increase in the firing voltage is prevented.

Accordingly, Xe content may be equal to or more than 10 wt % based on total weight of the discharge gas in the plasma display panel according to an exemplary embodiment. Hence, a luminance of an image displayed on the plasma display panel can be improved.

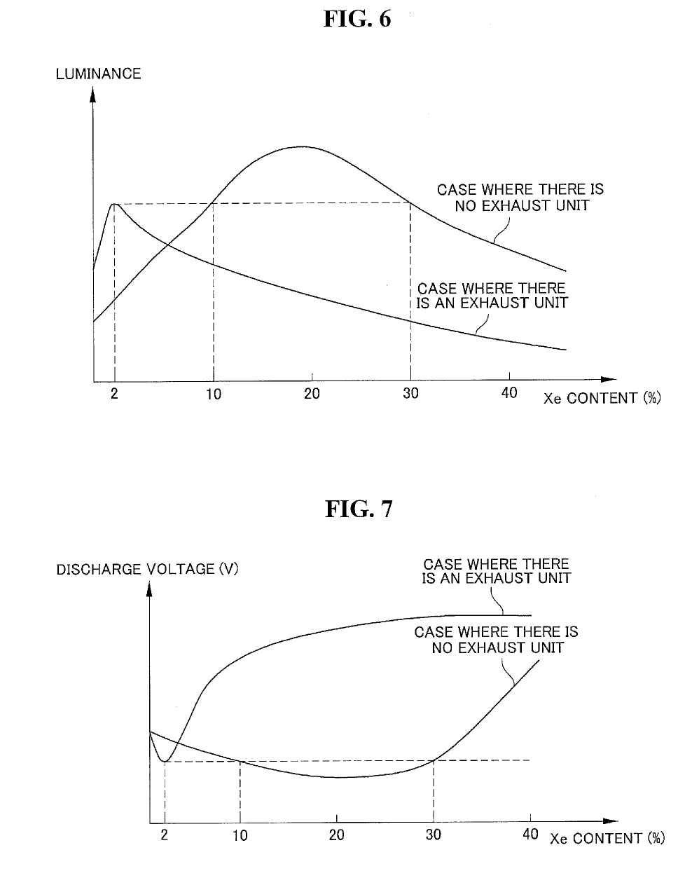

FIG. 6 is a graph showing a relationship between xenon (Xe) content and a luminance depending on whether or not there is an exhaust unit. As illustrated in FIG. 6, in case that there is no exhaust unit in the plasma display panel, the discharge gas is uniformly injected into the plasma display panel and a firing voltage is lowered. When an equal firing voltage is supplied to the plasma display panel including the exhaust unit and the plasma display panel not including the exhaust unit, a luminance of light emitted from the plasma display panel not including the exhaust unit is larger than a luminance of light emitted from the plasma display panel including the exhaust unit when Xe content ranges from 10 to 30 wt % based on total weight of the discharge gas. The discharge gas of the plasma display panel including the exhaust unit includes 2 wt % of Xe based on total weight of the discharge gas.

FIG. 7 is a graph showing a relationship between Xe content and a discharge voltage depending on whether or not there is an exhaust unit. As illustrated in FIG. 7, in case that there is no exhaust unit in the plasma display panel, the discharge gas is uniformly injected into the plasma display panel and a firing voltage is lowered. When Xe content ranges from 10 to 30 wt % based on total weight of the discharge gas, the plasma display panel not including the exhaust unit generates a discharge at 200V, but the plasma display panel including the exhaust unit cannot generate a discharge at 200V. The discharge gas of the plasma display panel including the exhaust unit includes 2 wt % of Xe based on total weight of the discharge gas.

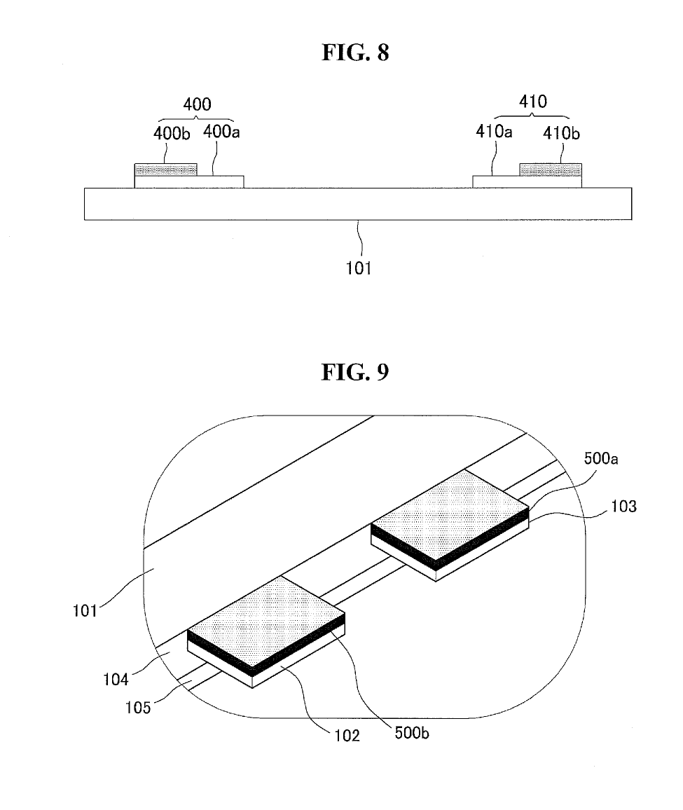

FIG. 8 illustrates a reason why a first electrode and a second electrode have a single-layered structure in a plasma display panel not including an exhaust tip.

As illustrated in FIG. 8, unlike the structure of the plasma display panel according to an exemplary embodiment, a first electrode 400 and a second electrode 410 formed on the front substrate 101 have a multi-layered structure. More specifically, the first electrode 400 and the second electrode 410 each include transparent electrodes 400a and 410a and bus electrodes 400b and 410b.

In FIG. 8, the transparent electrodes 400a and 410a are formed and then the bus electrodes 400b and 410b are formed to complete the first electrode 400 and the second electrode 410.

Accordingly, the number of fabrication processes and the fabrication cost increase in a case of FIG. 8 as compared with the plasma display panel according to an exemplary embodiment. Further, because a case of FIG. 8 uses relatively expensive ITO, the fabrication cost further increases.

On the other hand, because at least one of the first electrode or the second electrode includes a single layer in an exemplary embodiment, a fabrication process is simple. Further, because the first electrode or the second electrode does not use ITO, the fabrication cost is reduced.

When at least one of the first electrode or the second electrode is a bus electrode, an aperture ratio may be reduced because a color of the bus electrode may be darker than a color of the upper dielectric layer. When widths of the first and second electrodes decrease so as to raise the aperture ratio, a firing voltage increases and thus the driving efficiency may be reduced.

However, the discharge gas is uniformly distributed inside the plasma display panel and the firing voltage is lowered in the plasma display panel according to an exemplary embodiment not including the exhaust tip. Therefore, although at least one of the first electrode or the second electrode includes a single layer or the widths of the first and second electrodes decrease, a sharp increase in the firing voltage is prevented.

At least one of the first electrode or the second electrode including the single layer may include an opaque metal material with electrical conductivity. For instance, an inexpensive material having excellent electrical conductivity such as silver (Ag), copper (Cu) and aluminum (Al) may be used.

FIG. 9 illustrates a structure of a plasma display panel in which a black layer is added between first and second electrodes and a front substrate.

As illustrated in FIG. 9, black layers 500a and 500b are positioned between the front substrate 101 and the first and second electrodes 102 and 103, thereby preventing discoloration of the front substrate 101. Colors of the black layers 500a and 500b are darker than a color of at least one of the first electrode 102 or the second electrode 103.

When the front substrate 101 directly contacts the first and second electrodes 102 and 103, a predetermined area of the front substrate 101 directly contacting the first and second electrodes 102 and 103 may change to yellow. The change of color is called a migration phenomenon. The black layers 500a and 500b prevent the migration phenomenon by preventing the direct contact of the front substrate 101 and the first and second electrodes 102 and 103. The black layers 500a and 500b may include a black material of a dark color, for instance, ruthenium (Ru).

When the black layers 500a and 500b are positioned between the front substrate 101 and the first and second electrodes 102 and 103, the generation of reflection light can be prevented even if reflectivity of the first and second electrodes 102 and 103 is high.

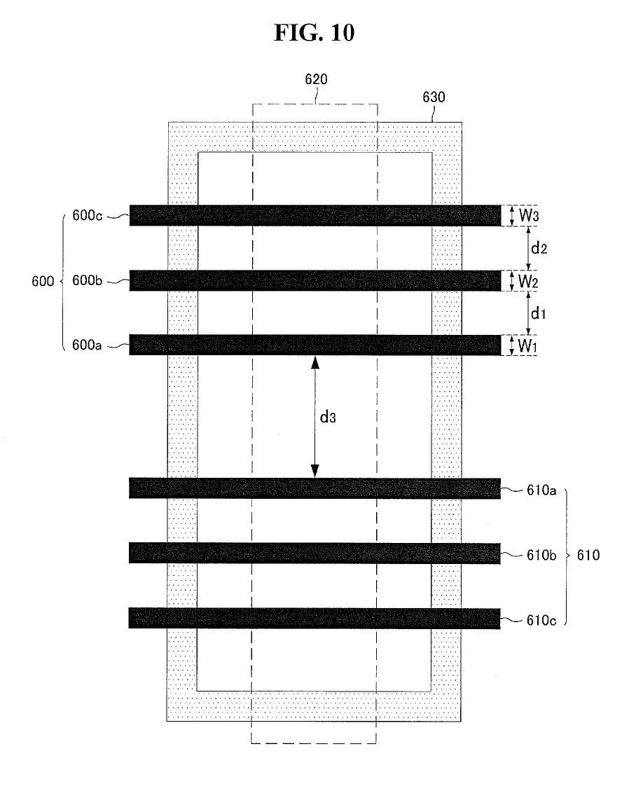

FIG. 10 illustrates a first exemplary embodiment associated with a first electrode and a second electrode in a plasma display panel according to an exemplary embodiment.

As illustrated in FIG. 10, a first electrode 600 and a second electrode 610 include a plurality of line portions 600a, 600b and 600c and a plurality of line portions 610a, 610b and 610c, respectively. The line portions 600a, 600b, 600c, 610a, 610b and 610c are formed to intersect a third electrode 620 within a discharge cell partitioned by a barrier rib 630.

The line portions 600a, 600b, 600c, 610a, 610b and 610c are spaced apart from one another with a predetermined distance therebetween. For instance, the first and second line portions 600a and 600b of the first electrode 600 are spaced apart from each other with a distance d1, and the second and third line portions 600b and 600c of the first electrode 600 are spaced apart from each another with a distance d2. The distances d1 and d2 may be equal to or different from each other. Widths W1, W2 and W3 of the first, second and third line portions 600a, 600b and 600c of the first electrode 600 may be equal to one another. A shape of the first electrode 600 may be symmetrical or asymmetrical to a shape of the second electrode 610 within the discharge cell.

When the shapes of the first and second electrodes 600 and 610 are asymmetrical, the first electrode 600 may include three line portions and the second electrode 610 may include two line portions.

A discharge may occur between the first line portion 600a and the first line portion 610a which are opposite to each other at a distance d3 therebetween. The above discharge may be diffused between the second line portion 600b and the second line portion 610b and between the third line portion 600c and the third line portion 610c.

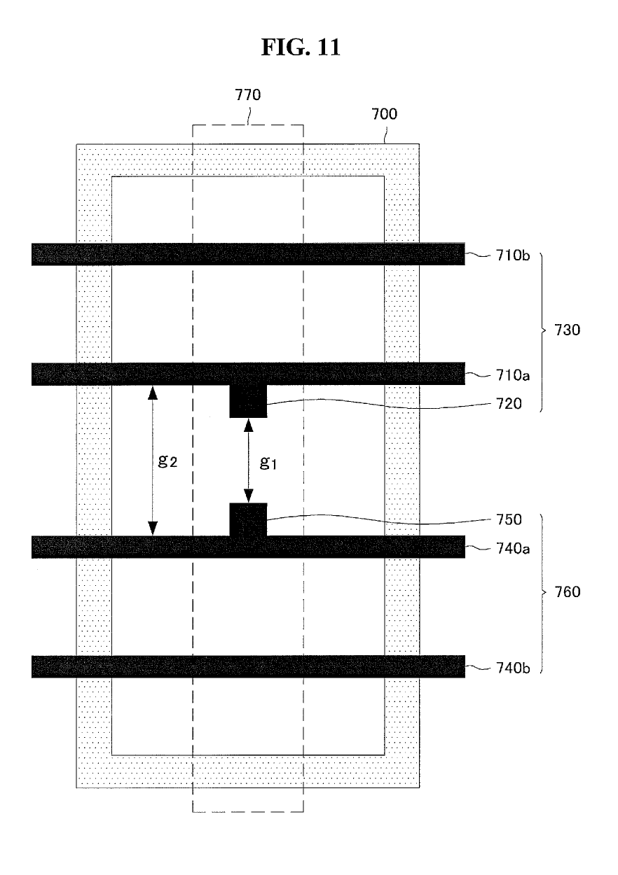

FIGS. 11 to 13 illustrate a second exemplary embodiment associated with a first electrode and a second electrode in a plasma display panel according to an exemplary embodiment. The description of structures and components identical or equivalent to those illustrated and described in FIG. 5 is briefly made or is entirely omitted in FIGS. 11 to 13.

As illustrated in FIG. 11, a first electrode 730 includes a plurality of line portions 710a and 710b and a projecting portion 720, and a second electrode 760 includes a plurality of line portions 740a and 740b and a projecting portion 750. The line portions 710a, 710b, 740a and 740b intersect a third electrode 770, and the projecting portions 720 and 750 are in parallel to the third electrode 770.

The projecting portions 720 and 750 project from the one or more line portions 710a, 710b, 740a and 740b. For instance, the projecting portion 720 projects from the line portions 710a, and the projecting portion 750 projects from the line portions 740a.

A distance g1 between the first electrode 730 and the second electrode 760 in a formation area of the projecting portions 720 and 750 is shorter than a distance g2 between the first electrode 730 and the second electrode 760 in an area except the formation area of the projecting portions 720 and 750 inside a discharge cell partitioned by a barrier rib 700. Thus, a firing voltage of a discharge generated between the first electrode 730 and the second electrode 760 can be lowered.

The projecting portions 720 and 750 may overlap the third electrode 770 inside the discharge cell. Hence, a firing voltage between the first electrode 730 and the third electrode 770 and a firing voltage between the second electrode 760 and the third electrode 770 can be lowered.

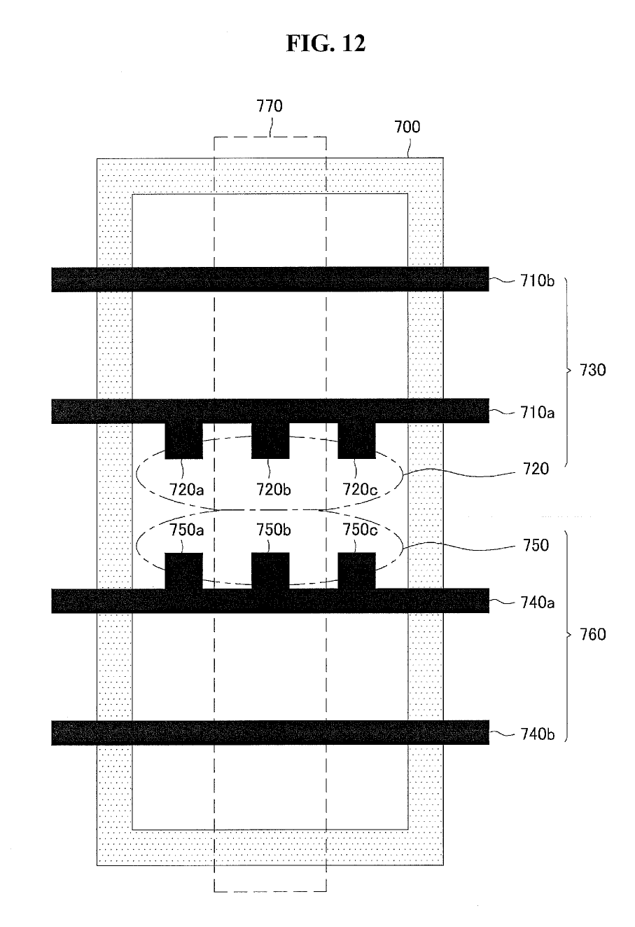

As illustrated in FIG. 12, a plurality of projecting portions 720a, 720b, 720c, 750a, 750b and 750c are formed. For instance, the first electrode 730 includes the three projecting portions 720a, 720b and 720c, and the second electrode 760 includes the three projecting portions 750a, 750b and 750c.

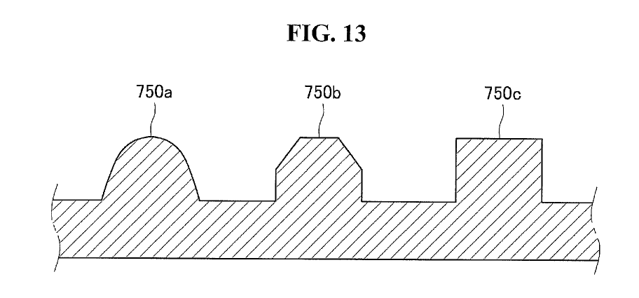

As illustrated in FIG. 13, the projecting portions 750a, 750b and 750c may have various shapes. For instance, the projecting portions 750a, 750b and 750c may have an end of a curved surface or a polygon.

The shape of at least one of the plurality of projecting portions may be different from the shapes of the other projecting portions. For instance, one of two projecting portions may have an end of a curved surface in the same way as the projecting portion 750a of FIG. 13, and the other may have an end of a rectangle in the same way as the projecting portion 750c of FIG. 13.

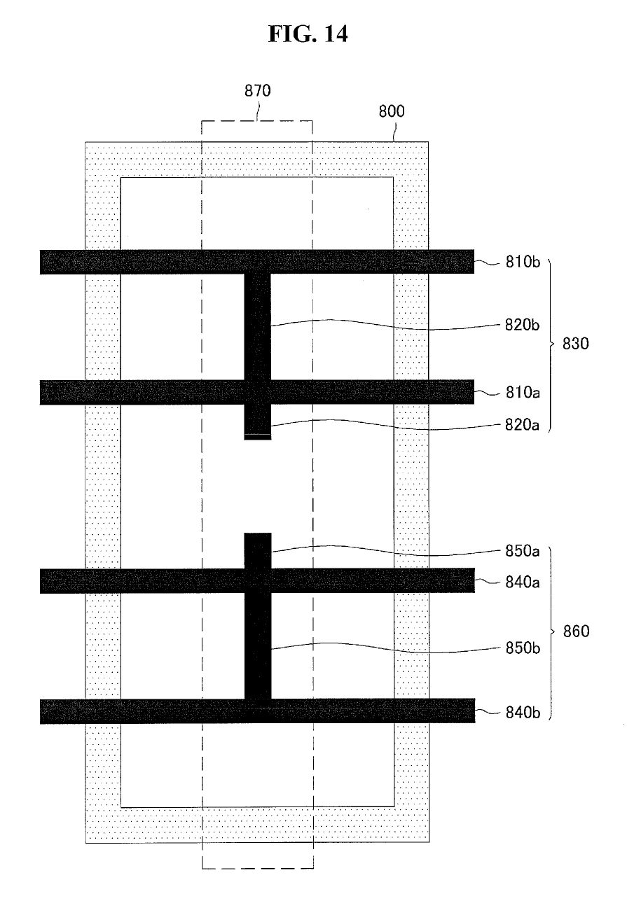

FIG. 14 illustrates a third exemplary embodiment associated with a first electrode and a second electrode in a plasma display panel according to an exemplary embodiment. The description of structures and components identical or equivalent to those illustrated and described in the first and second exemplary embodiments is briefly made or is entirely omitted in FIG. 14.

As illustrated in FIG. 14, connection portions 820b and 850b connecting two or more line portions of a plurality of line portions 810a, 810b, 840a and 840b are formed.

For instance, the connection portion 820b of a first electrode 830 connects the first and second line portions 810a and 810b of the first electrode 830. The connection portion 850b of a second electrode 860 connects the first and second line portions 840a and 840b of the second electrode 860.

The connection portions 820b and 850b connecting the two line portions make it easy to diffuse a discharge generated inside a discharge cell partitioned by a barrier rib 800.

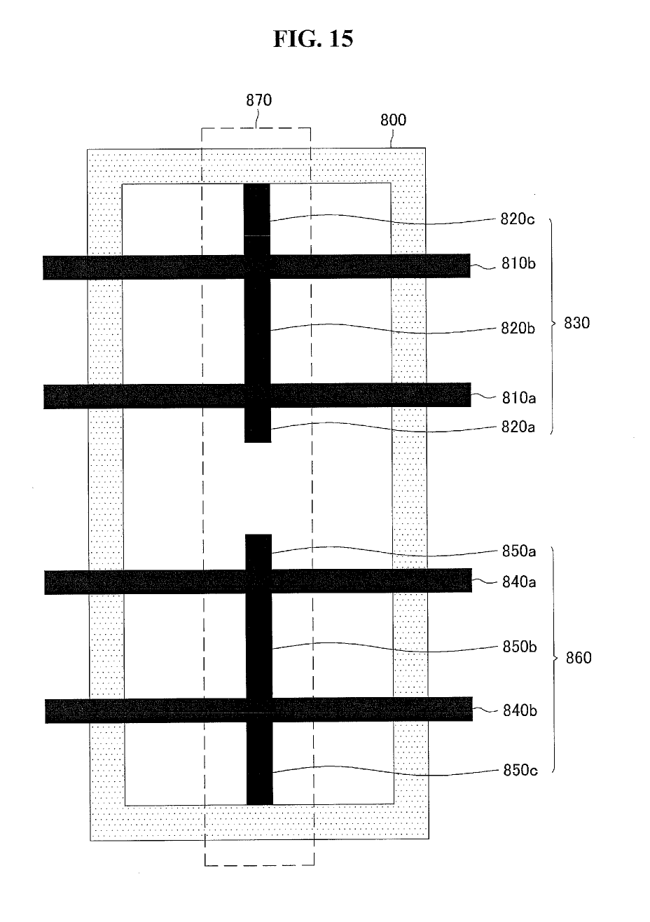

FIG. 15 illustrates a fourth exemplary embodiment associated with a first electrode and a second electrode in a plasma display panel according to an exemplary embodiment. The description of structures and components identical or equivalent to those illustrated and described in the first to third exemplary embodiments is briefly made or is entirely omitted in FIG. 15.

As illustrated in FIG. 15, at least one of a plurality of projecting portions 820a, 820c, 850a and 850c projects from at least one of a plurality of line portions 810a, 810b, 840a and 840b in a first direction. At least one of the other projecting portions projects from at least one of the plurality of line portions 810a, 810b, 840a and 840b in a second direction different from the first direction. The first direction may be opposite to the second direction.

For instance, the projecting portion 820a projects from the line portion 810a toward the center of the discharge cell. The projecting portion 820c projects from the line portion 810b in an opposite direction of a projecting direction of the projecting portion 820a. The projecting portions 820c and 850c serve to more widely diffuse a discharge generated inside the discharge cell.

Although FIG. 15 has illustrated a case where the first and second electrodes 830 and 860 include the projecting portions 820a and 850a projecting toward the center of the discharge cell, respectively, the first and second electrodes 830 and 860 each may include one or more projecting portions projecting toward the center of the discharge cell. The projecting portions 820a and 850a lower a firing voltage, and efficiently diffuse a discharge.

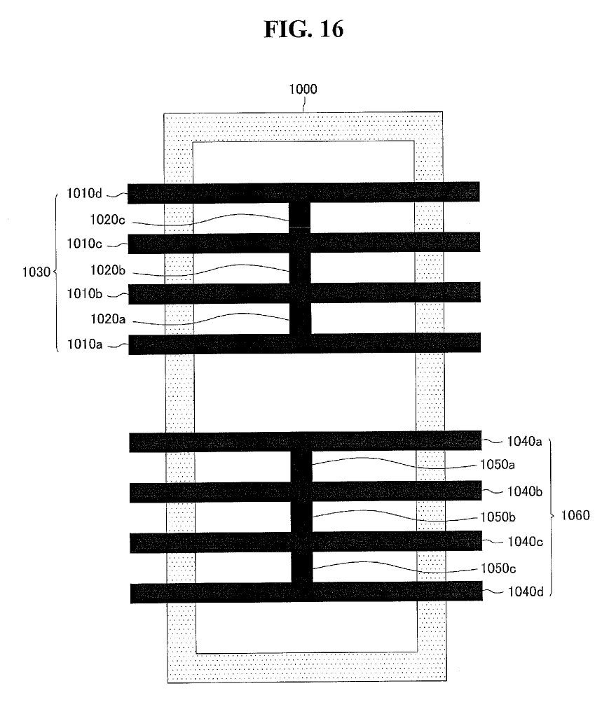

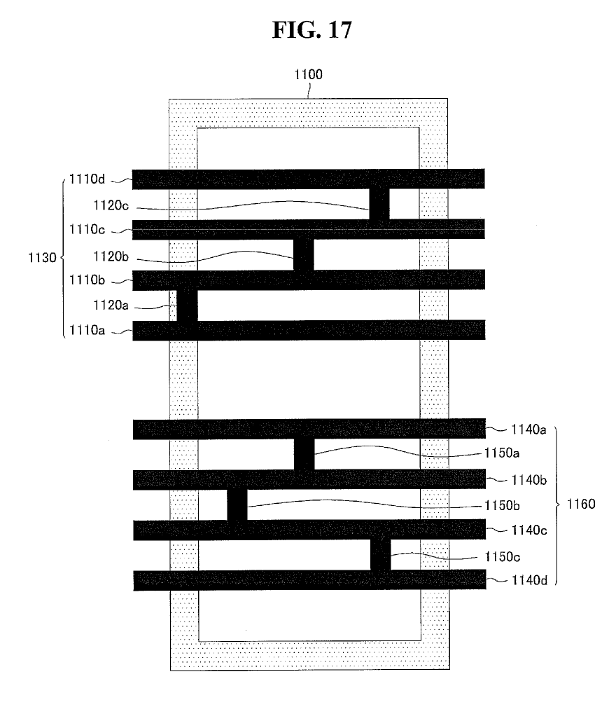

FIG. 16 illustrates a fifth exemplary embodiment associated with a first electrode and a second electrode in a plasma display panel according to an exemplary embodiment. The description of structures and components identical or equivalent to those illustrated and described in the first to fourth exemplary embodiments is briefly made or is entirely omitted in FIG. 16.

As illustrated in FIG. 16, a first electrode 1030 includes four line portions 101a, 110b, 1010c and 1010d, and three connection portions 1020a, 1020b and 1020c. A second electrode 1060 includes four line portions 1040a, 1040b, 1040c and 1040d, and three connection portions 1050a, 1050b and 1050c. The connection portions each connect two or more line portions.

For instance, in a case of the first electrode 1030, the first connection portion 1020a connects the first and second line portions 1010a and 1010b, the second connection portion 1020b connects the second and third line portions 1010b and 1010c, and the third connection portion 1020c connects the third and fourth line portions 1010c and 1010d.

FIG. 17 illustrates a sixth exemplary embodiment associated with a first electrode and a second electrode in a plasma display panel according to an exemplary embodiment. The description of structures and components identical or equivalent to those illustrated and described in the first to fifth exemplary embodiments is briefly made or is entirely omitted in FIG. 17.

As illustrated in FIG. 17, a first electrode 1130 includes four line portions 1110a, 110b, 1110c and 1110d, and three connection portions 1120a, 1120b and 1120c. A second electrode 1160 includes four line portions 1140a, 1140b, 1140c and 1140d, and three connection portions 1150a, 1150b and 1150c. At least one of the three connection portions of each of the first and second electrodes 1130 and 1160 is different from the other connection portions in a formation location.

For instance, in a case of the first electrode 11301 formation locations of the first and second connection portions 1120a and 1120b are different from each other, and formation locations of the second and third connection portions 1120b and 1120c are different from each other.

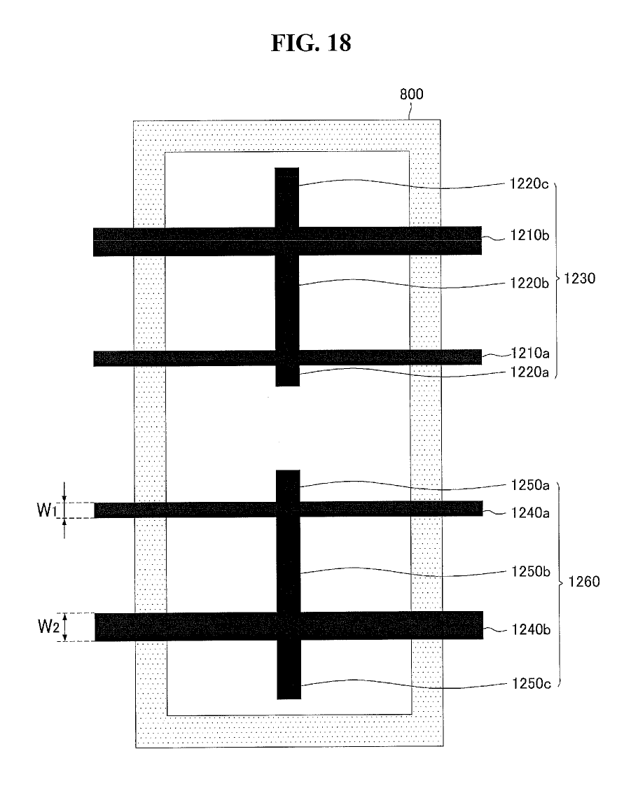

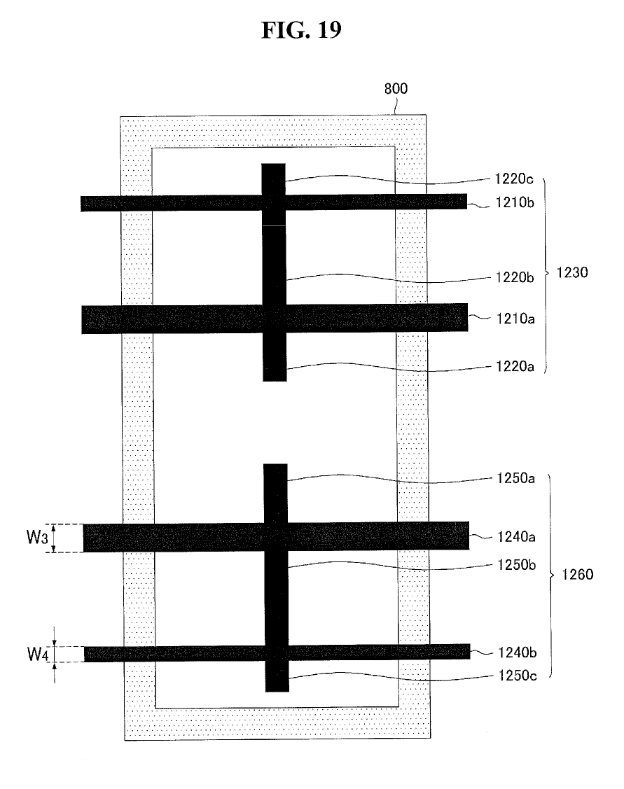

FIGS. 18 and 19 illustrate a seventh exemplary embodiment associated with a first electrode and a second electrode in a plasma display panel according to an exemplary embodiment. The description of structures and components identical or equivalent to those illustrated and described in the first to sixth exemplary embodiments is briefly made or is entirely omitted in FIGS. 18 and 19.

As illustrated in FIG. 18, a shape of at least one of a plurality of line portions of each of first and second electrodes 1230 and 1260 is different from a shape of the other line portions. For instance, a width W1 of a first line portion 1240a of the second electrode 1260 may be smaller than a width W2 of a second line portion 1240b.

As illustrated in FIG. 19, a width W3 of the first line portion 1240a of the second electrode 1260 may be larger than a width W4 of the second line portion 1240b.

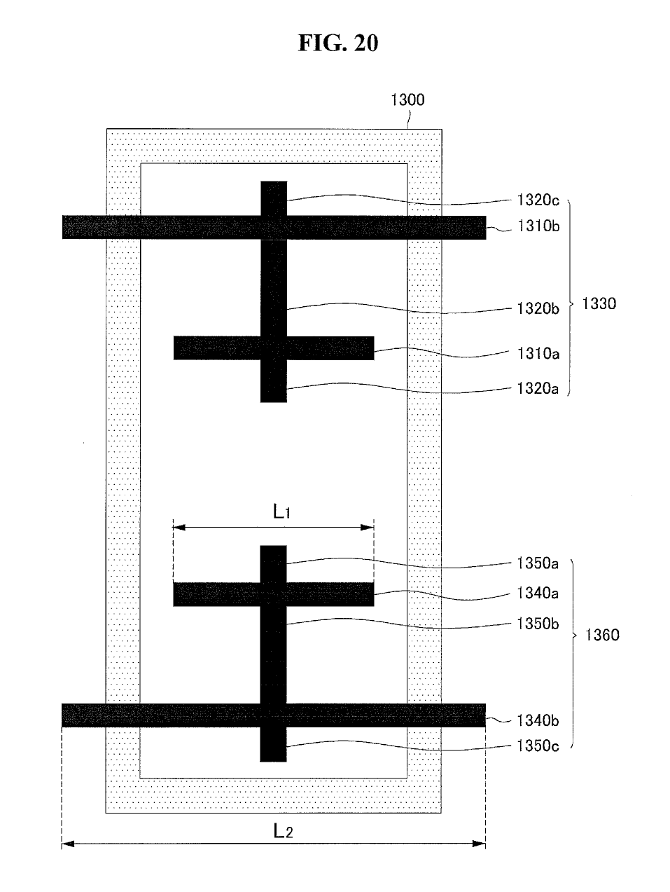

FIG. 20 illustrates an eighth exemplary embodiment associated with a first electrode and a second electrode in a plasma display panel according to an exemplary embodiment. The description of structures and components identical or equivalent to those illustrated and described in the first to seventh exemplary embodiments is briefly made or is entirely omitted in FIG. 20.

As illustrated in FIG. 20, a shape of at least one of a plurality of line portions of each of first and second electrodes 1330 and 1360 is different from a shape of the other line portions. For instance, a length L1 of a first line portion 1340a of the second electrode 1360 may be shorter than a length L2 of a second line portion 1340b. Further, the length L1 may be longer than the length L2.

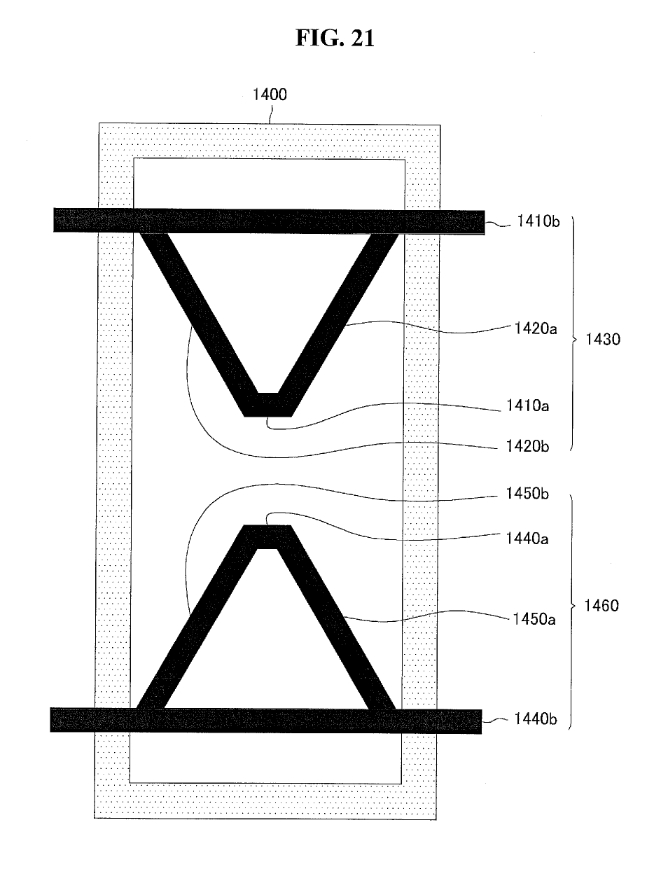

FIG. 21 illustrates a ninth exemplary embodiment associated with a first electrode and a second electrode in a plasma display panel according to an exemplary embodiment. The description of structures and components identical or equivalent to those illustrated and described in the first to eighth exemplary embodiments is briefly made or is entirely omitted in FIG. 21.

As illustrated in FIG. 21, a first electrode 1430 includes a first line portion 1410a and a second line portion 1410b having a length longer than the first line portion 1410a. A second electrode 1460 includes a first line portion 1440a and a second line portion 1440b having a length longer than the first line portion 1440a.

Further, the first and second electrodes 1430 and 1460 each include first connection portions 1420a and 1450a, and second connection portions 1420b and 1450b. The first and second connection portions 1420a and 1420b of the first electrode 1430 project at a given angle to the first line portions 1410a, and connect the first and second line portions 1410a and 1410b to each other. The first and second connection portions 1450a and 1450b of the second electrode 1460 project at a given angle to the first line portions 1450a, and connect the first and second line portions 1440a and 1440b to each other.

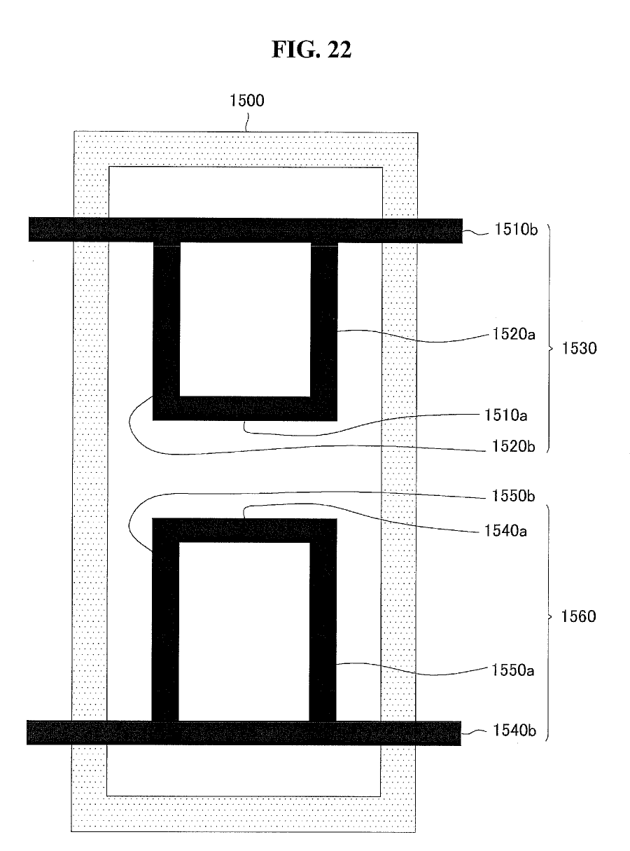

FIG. 22 illustrates a tenth exemplary embodiment associated with a first electrode and a second electrode in a plasma display panel according to an exemplary embodiment. The description of structures and components identical or equivalent to those illustrated and described in the first to ninth exemplary embodiments is briefly made or is entirely omitted in FIG. 22.

As illustrated in FIG. 22, first and second electrodes 1530 and 1560 have a rectangular shape. As illustrated in FIGS. 21 and 22, the first and second electrodes in the plasma display panel according to an exemplary embodiment may have various polygonal shapes.

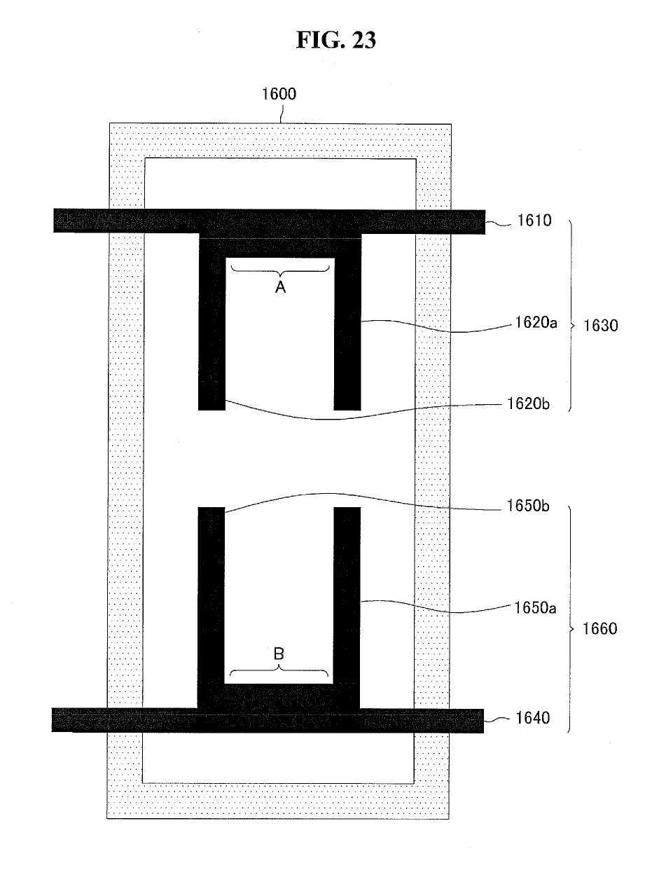

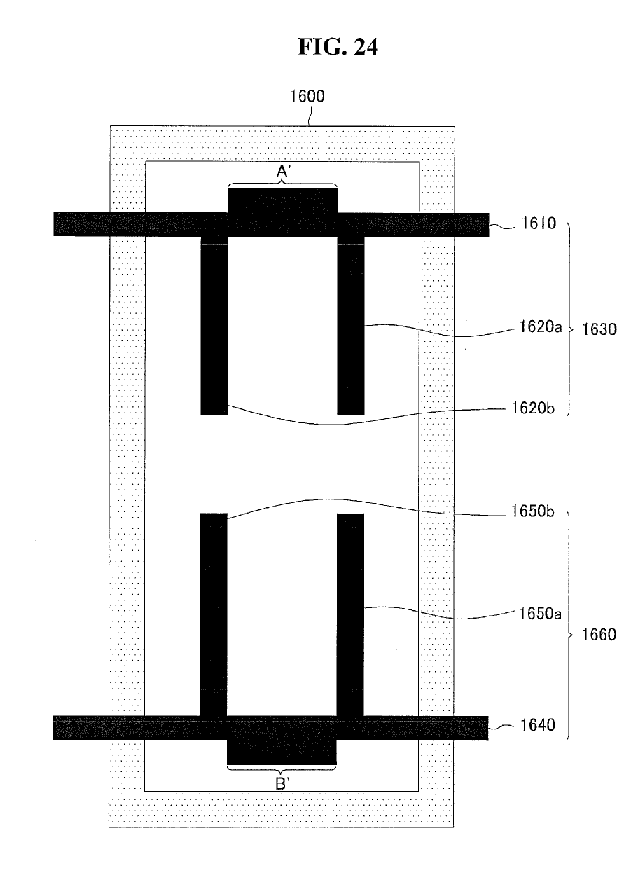

FIGS. 23 and 24 illustrate an eleventh exemplary embodiment associated with a first electrode and a second electrode in a plasma display panel according to an exemplary embodiment. The description of structures and components identical or equivalent to those illustrated and described in the first to tenth exemplary embodiments is briefly made or is entirely omitted in FIGS. 23 and 24.

As illustrated in FIG. 23, middle portions A and B of line portions 1610 and 1640 of first and second electrodes 1630 and 1660 project toward the center of a discharge cell partitioned by a barrier rib 1600. As illustrated in FIG. 24, middle portions A′ and B′ of the line portions 1610 and 1640 of the first and second electrodes 1630 and 1660 project in an opposite direction of a projecting direction of the middle portions A and B of FIG. 23.

The plasma display panel according to an exemplary embodiment includes lead (Pb) equal to or less than 1,000 PPM (parts per million). In other words, the total Pb content in the plasma display panel may be equal to or less than 1,000 PPM by setting a sum of a content of Pb included in all components of the plasma display panel to be equal to or less than 1,000 PPM.

Pb content in a specific component of the plasma display panel may be equal to or less than 1,000 PPM. For instance, Pb content in the barrier rib and/or the dielectric layer may be equal to or less than 1,000 PPM.

Pb content in each component of the plasma display panel may be equal to or less than 1,000 PPM. In other words, Pb content in each of the barrier rib, the dielectric layer, the electrode, the phosphor layer and the seal layer may be equal to or less than 1,000 PPM.

Sine the total Pb content in the plasma display panel is equal to or less than 1,000 PPM, Pb contained in the plasma display panel does not adversely affect to the human body.

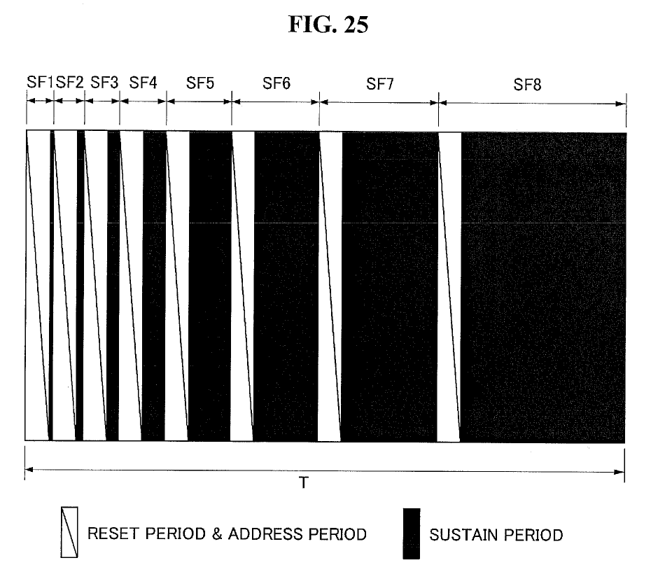

FIG. 25 illustrates a frame for achieving a gray scale of an image displayed on a plasma display panel according to an exemplary embodiment.

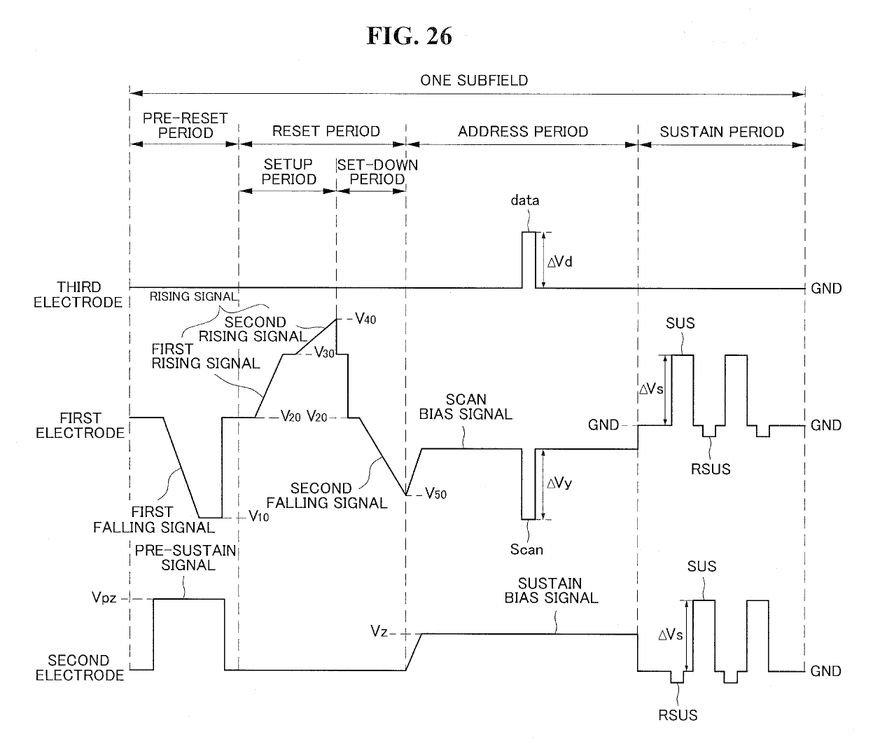

FIG. 26 illustrates an operation of a plasma display panel according to an exemplary embodiment.

Referring to FIG. 25, a frame for achieving a gray scale of an image displayed on the plasma display panel according to an exemplary embodiment is divided into several subfields each having a different number of emission times.

Each subfield is subdivided into a reset period for initializing all the discharge cells, an address period for selecting cells to be discharged, and a sustain period for representing a gray scale in accordance with the number of discharges.

For instance, if an image with 256-level gray scale is to be displayed, a frame is divided into 8 subfields SF1 to SF8. Each of the 8 subfields SF1 to SF8 is subdivided into a reset period, an address period, and a sustain period. One frame may include 8 or more subfields.

The number of sustain signals supplied during the sustain period determines gray level weight in each subfield. For instance, the sustain period increases in a ratio of 2ⁿ (where, n=0, 1, 2, 3, 4, 5, 6, 7) in each subfield. An image having various gray levels is achieved by controlling the number of sustain signals supplied during a sustain period of each subfield depending on gray level weight in each subfield.

Although FIG. 25 has illustrated and described the subfields arranged in increasing order of gray level weight, the subfields may be arranged in decreasing order of gray level weight, or the subfields may be arranged regardless of gray level weight.

As illustrated in FIG. 26, during a pre-reset period, a first falling signal is supplied to the first electrode Y. During the supplying of the first falling signal to the first electrode Y, a pre-sustain signal of an opposite polarity direction of a polarity direction of the first falling signal is supplied to the second electrode Z.

The first falling signal supplied to the first electrode Y gradually falls to a tenth voltage V10. The pre-sustain signal is constantly maintained at a pre-sustain voltage Vpz. The pre-sustain voltage Vpz is substantially equal to a sustain voltage Vs of a sustain signal (SUS) which will be supplied during a sustain period.

Since the first falling signal is supplied to the first electrode Y and the pre-sustain signal is supplied to the second electrode Z during the pre-reset period, wall charges of a positive polarity are accumulated on the first electrode Y and wall charges of a negative polarity are accumulated on the second electrode Z.

The wall charges accumulated on the first electrode Y and the second electrode Z during the pre-reset period can generate a stable setup discharge although a maximum voltage of a rising signal supplied to the first electrode Y during a reset period is not high.

A subfield, which is first arranged in time order in a plurality of subfields of one frame, may include a pre-reset period prior to a reset period so as to obtain sufficient driving time. Otherwise, two or three subfields may include a pre-reset period prior to a reset period. All the subfields may not include a pre-reset period.

The reset period is further divided into a setup period and a set-down period. During the setup period, a rising signal is supplied to the first electrode Y. The rising signal includes a first rising signal and a second rising signal. The first rising signal gradually rises from a twentieth voltage V20 to a thirtieth voltage V30 with a first slope, and the second rising signal gradually rises from the thirtieth voltage V30 to a fortieth voltage V40 with a second slope.

The rising signal generates a weak dark discharge (i.e., a setup discharge) inside the discharge cell during the setup period. The second slope may be gentler than the first slope. When the second slope is gentler than the first slope, a voltage level of the rising signal rises relatively rapidly until the setup discharge occurs, and a voltage level of the rising signal rises relatively slowly during the generation of the setup discharge. As a result, the quantity of light generated by the setup discharge is reduced. Accordingly, contrast of the plasma display apparatus is improved.

During the set-down period, a second falling signal is supplied to the first electrode Y. The second falling signal gradually falls from the twentieth voltage V20 to a fiftieth voltage V50.

The second falling signal generates a weak erase discharge (i.e., a set-down discharge) inside the discharge cell. Furthermore, the remaining wall charges are uniform inside the discharge cells to the extent that an address discharge can be stably performed.

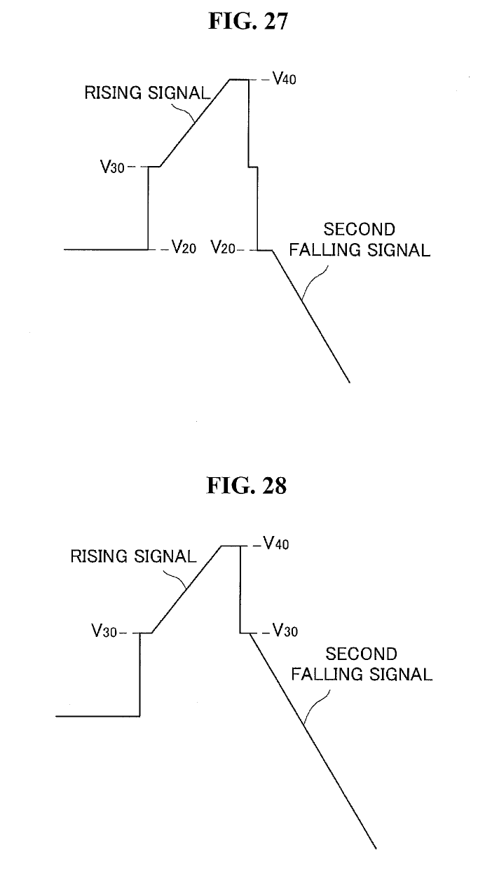

FIGS. 27 and 28 illustrate another form of a rising signal and a second falling signal.

As illustrated in FIG. 27, the rising signal sharply rises to the thirtieth voltage V30, and then gradually rises from the thirtieth voltage V30 to the fortieth voltage V40.

The rising signal, as illustrated in FIG. 26, may gradually rise with two different slopes. Further, the rising signal, as illustrated in FIG. 27, may gradually rise with one slope.

As illustrated in FIG. 28, the second falling signal gradually falls from the thirtieth voltage V30. As above, a voltage falling time point of the second falling signal may be changed.

Referring again to FIG. 26, during an address period, a scan bias signal, which is maintained at a voltage level higher than the fiftieth voltage V50 of the second falling signal, is supplied to the first electrode Y.

A scan signal (Scan), which falls from the scan bias signal by a scan voltage magnitude ΔVy, is sequentially supplied to all the first electrodes Y1 to Yn.

The width of the scan signal may vary from one subfield to the next subfield. In other words, the width of a scan signal in at least one subfield may be different from the width of a scan signal in the other subfields.

When the scan signal (Scan) is supplied to the first electrode Y, a data signal (data) corresponding to the scan signal (Scan) is supplied to the third electrode X. The data signal (data) rises from a ground level voltage GND by a data voltage magnitude ΔVd.

As the scan signal (Scan) and the data signal (data) are supplied, an address discharge occurs inside the discharge cell to which the data signal (data) is supplied.

A sustain bias signal is supplied to the second electrode Z during the address period so as to smoothly generate the address discharge between the first electrode Y and the third electrode X. The sustain bias signal is substantially maintained at a sustain bias voltage Vz. The sustain bias voltage Vz is lower than the sustain voltage Vs of the sustain signal (SUS) and is higher than the ground level voltage GND.

During the sustain period, a sustain signal (SUS) is alternately supplied to the first electrode Y and the second electrode Z. When the sustain signal (SUS) is supplied, a sustain discharge occurs inside the discharge cells selected be performing the address discharge.

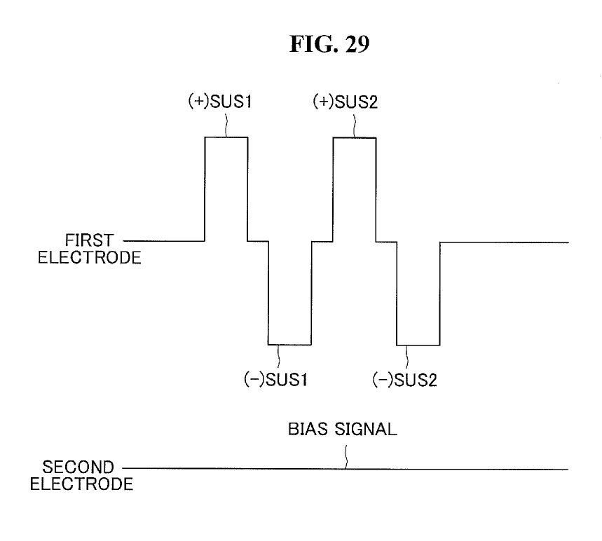

FIG. 29 illustrates another type of a sustain signal. As illustrated in FIG. 29, a sustain signal ((+)SUS1, (+)SUS2) of a positive polarity and a sustain signal ((−)SUS1, (−)SUS2) of a negative polarity are alternately supplied to the first electrode Y or the second electrode Z, for instance, to the first electrode Y in FIG. 29.

When the sustain signal of the positive polarity and the sustain signal of the negative polarity are alternately supplied to the first electrode Y, a bias signal is supplied to the second electrode Z. The bias signal is constantly maintained at the ground level voltage GND.

As illustrated in FIG. 29, when the sustain signal is supplied to either the first electrode Y or the second electrode Z, a single diving board for installing a circuit for supplying the sustain signal to either the first electrode Y or the second electrode Z is required. Accordingly, the whole size of a driver for driving the plasma display panel is reduced such that the fabrication cost is reduced.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display panel comprising:
a front substrate on which a first electrode and a second electrode are positioned in parallel;
a rear substrate, opposite to the front substrate, on which a third electrode is positioned to intersect the first electrode and the second electrode; and
a barrier rib which is positioned between the front substrate and the rear substrate and partitioning a discharge cell,
wherein the discharge cell is filled with a discharge gas including 10 to 30 wt % of xenon (Xe) based on total weight of the discharge gas,
the barrier rib comprises a first barrier rib and a second barrier rib intersecting each other,
a height of the first barrier rib is substantially the same as a height of the second barrier rib, and
an exhaust unit is omitted from the front substrate and the rear substrate.

2. The plasma display panel of claim 1, wherein a seal layer is positioned between the front substrate and the rear substrate, and coalesces the front substrate and the rear substrate, and
the seal layer comprises a photo-crosslinked material.

3. The plasma display panel of claim 1, wherein the discharge gas comprises 13 to 30 wt % of Xe based on total weight of the discharge gas.

4. The plasma display panel of claim 1, wherein at least one of the first electrode or the second electrode comprises one layer.

5. The plasma display panel of claim 4, wherein the first electrode and the second electrode are positioned symmetrically each other inside the discharge cell.

6. The plasma display panel of claim 4, wherein a black layer is positioned on at least one of the first electrode or the second electrode.

7. The plasma display panel of claim 4, wherein at least one of the first electrode or the second electrode comprises a line portion intersecting the third electrode and a projecting portion, which is positioned in parallel to the third electrode and projects from the line portion.

8. The plasma display panel of claim 7, wherein at least one of the first electrode or the second electrode comprises a plurality of line portions and a connection portion connecting the plurality of the line portions.

9. The plasma display panel of claim 8, wherein at least one of the first electrode or the second electrode comprises a plurality of the line portions and a plurality of connection portions connecting the plurality of the line portions, and
the plurality of connection portions are arranged in the form of a straight line.

10. The plasma display panel of claim 7, wherein the projecting portion comprises a first projecting portion and a second projecting portion, and
the first projecting portion projects in a first direction and the second projecting portion projects in a second direction different from the first direction.

11. The plasma display panel of claim 7, wherein the projecting portion has an end of a curved surface.

12. The plasma display panel of claim 7, wherein at least one of the first electrode or the second electrode comprises a first line portion and a second line portion, and a width of the first line portion close to a center of a discharge cell is less than a width of the second line portion close to a barrier rib.

13. The plasma display panel of claim 7, wherein at least one of the first electrode or the second electrode comprises a first line portion and a second line portion, and a width of the first line portion close to a center of a discharge cell is larger than a width of the second line portion close to a barrier rib.

14. The plasma display panel of claim 7, wherein at least one of the first electrode or the second electrode comprises a first line portion and a second line portion, and a length of the first line portion close to a center of a discharge cell is less than a length of the second line portion close to a barrier rib.

15. The plasma display panel of claim 8, wherein the connection portion projects at a given angle to the line portion.

16. The plasma display panel of claim 7, wherein at least one of the first electrode or the second electrode comprises a plurality of projecting portions, and a thickness of a portion of the projecting portion is greater than a thickness of the rest portion of the projecting portion, and
wherein the portion of the projecting portion is positioned between the plurality of projecting portions.

17. The plasma display panel of claim 4, wherein one layer is a bus electrode.

18. The plasma display panel of claim 1, wherein the exhaust unit comprises an exhaust hole.

19. The plasma display panel of claim 1, wherein the discharge cell comprises a first discharge cell and a second discharge cell,
a first phosphor is positioned inside the first discharge cell, and a second phosphor is positioned inside the second discharge cell, and
a thickness of the first phosphor is different from a thickness of the second phosphor.
